(19) United States
(12) Patent Application Publication
(10) Pub. No.: US 2006/0217490 A1
(43) Pub. Date: Sep. 28, 2006

(54) Polyethylene compositions having improved printability

(76) Inventors: Chun D. Lee, Cincinnati, OH (US); Jeffrey A. Jones, Morrow, OH (US)

Correspondence Address: WILLIAM A. HEIDRICH;Equistar Chemicals, LP, 11530 Northlake Drive, Cincinnati, OH, 45249, US

(21) Appl. No.: 11/086,248

(22) Filed: Mar. 22, 2005

(51) Int. Cl. C08L 23/04

(52) U.S. Cl. 525/240

(57) ABSTRACT

Polyethylene compositions having improved printability are provided. The compositions which are comprised of a polyethylene base resin, polyethylene glycol and polyethylene modified with carboxylic acid or carboxylic acid derivative functionality are melt blended under conditions of mixing and shear to increase their melt elasticity.

### BACKGROUND OF THE INVENTION

1. Field of the Invention

The invention relates to polyethylene compositions. More specifically, the invention relates to polyethylene compositions having improved printability obtained by incorporating polyethylene glycol and modified polyethylene components therewith and to the process for obtaining the improved compositions

2. Description of the Prior Art

Polyethylene (PE) resins are widely used for the production of films, laminates and extrusion coatings in view of their ready processability, low cost and physical properties. However, due to the non-polar nature of the polymers and the smooth, non-porous nature of the surface of films, laminates and coatings produced therefrom, printability is poor.

Various post-treatment techniques have been employed to modify the surface characteristics, i.e., increase surface energy, of polyethylene substrates to improve printability, wettability and adhesion. Such post-treatment procedures have included corona discharge, flame treatment, ozone treatment, plasma treatment and various chemical treatments.

Whereas post-treatment procedures of the above types can enhance printability, they require additional steps in the manufacturing process. This not only requires additional capital outlays for the purchase, modification and maintenance of equipment but also can limit line speed.

It would be highly advantageous and desirable if polyethylene compositions which inherently exhibited improved printability and eliminated the need for post-treatment in all but the most critical applications were available. It would be even more desirable if these compositions were produced using economical and readily available components. These and other objectives are achieved with the compositions of the invention.

### SUMMARY OF THE INVENTION

The invention relates to polyethylene resin compositions having improved printability comprised of 85 to 98.75 weight percent, based on the total composition, polyethylene base resin, 0.25 to 5 weight percent, based on the total composition, polyethylene glycol having an average molecular weight from 500 to 20000, and 1 to 10 weight percent, based on the total composition, modified polyethylene resin containing carboxylic acid or carboxylic acid derivative functionality. More specifically, the polyethylene base resins employed for the invention are ethylene homopolymers or copolymers of ethylene and C₃₋₈ α-olefins having densities from 0.890 to 0.970 g/cm³ and melt indexes from 0.01 to 40 g/10 min. Particularly advantageous base resins include linear low density polyethylene having a density from 0.906 to 0.930 g/cm³ and melt index from 0.1 to 10 g/10 min., high density polyethylene having a density from 0.945 to 0.965 and melt index from 0.05 to 15 g/10 min., and low density polyethylene having a density from 0.910 to 0.930 g/cm³ and melt index from 0.5 to 20 g/10 min.

Highly useful compositions are obtained utilizing polyethylene glycols having average molecular weights from 1000 to 6000 and modified polyethylene resins grafted with 0.2 to 4 weight percent maleic anhydride. It is particularly advantageous when the modified polyethylene resin is high density polyethylene or linear low density polyethylene grafted with 0.2 to 4 weight percent maleic anhydride.

To obtain compositions having improved printability the base resin, polyethylene glycol and modified polyethylene are subjected to what is referred to herein as reactive compounding, that is, the components are combined and melt blended under conditions of mixing and shear to effect an increase in melt elasticity. The reactive compounding operation increases the melt elasticity of the melt compounded product by at least 20% and, more preferably, 25% or more over that of the base resin. Articles fabricated from compositions produced in the above manner consistently exhibit improved ink adhesion.

### DETAILED DESCRIPTION OF THE INVENTION

Compositions of the invention which exhibit improved adhesion with commonly used inks contain 85 to 98.75 weight percent (wt. %) polyethylene resin, 0.25 to 5 wt. % polyethylene glycol and 1 to 10 wt. % modified polyethylene. Compositions obtained by blending 90 to 96 wt. % polyethylene resin with 0.5 to 4 wt. % polyethylene glycol and 2.5 to 7.5 wt. % modified polyethylene are particularly advantageous. Weight percentages of the above components are based on the total weight of the composition.

Polyethylene (PE) resins employed for the invention, also referred to herein as the base resin since they constitute the major component of the blends, include ethylene homopolymers, ethylene-C₃₋₈ α-olefin copolymers and mixtures thereof. Additionally, minor amounts of other ethylene polymers may be included in the base resin. The particular base resin employed will depend on the intended application, i.e., whether the final composition will be extruded or cast into film, extrusion coated, injection molded, blow molded or the like, and the physical, chemical and rheological characteristics required for processing, fabrication and durability of the finished product.

Useful polyethylene resins for the base resin component(s) can include very low density polyethylene (VLDPE), low density polyethylene (LDPE), linear low density polyethylene (LLDPE and mLLDPE), medium density polyethylene (MDPE), high density polyethylene (HDPE) and very high or ultra high molecular weight polyethylene produced using known polymerization catalysts and procedures. The polyethylene resins can be produced using Ziegler catalysts or single-site catalysts. Metallocene single-site catalysts are transition metal compounds that contain cyclopentadienyl (Cp) or Cp derivative ligands (see U.S. Pat. No. 4,542,199). Non-metallocene single-site catalysts contain ligands other than Cp, usually heteroatomic ligands, e.g., boraaryl (see U.S. Pat. No. 6,034,027), pyrrolyl (see U.S. Pat. No. 5,539,124), azaborolinyl (see U.S. Pat. No. 5,756,611) and quinolinyl (see U.S. Pat. No. 5,637,660). Single-site catalysts typically produce polyethylenes having narrower molecular distributions.

Densities of polyethylene base resin(s) can range from about 0.890 up to about 0.970 g/cm³; however, for most applications the base resins will have densities from 0.905 to 0.965 g/cm³. Densities reported herein are determined in accordance with ASTM D 1505. Melt indexes (MIs) of the polyethylene base resin(s), determined in accordance with ASTM D 1238-01, condition 190/2.16, typically range from 0.01 to 50 g/10 min and, more preferably, from 0.1 to 30 g/10 min.

Other polymers which can be included in the base resin in minor amounts include copolymers of ethylene with comonomers containing polar groups such as C₁₋₄ alkyl esters of acrylic and methacrylic acids and vinyl esters of C₂₋₄ aliphatic acids. Such copolymers typically contain 1 to 35 weight percent and, more preferably, 2 to 25 weight percent polar comonomer. Included by way of illustration are ethylene-vinyl acetate copolymers, ethylene-methyl acrylate copolymers and ethylene-n-butyl acrylate copolymers. When the base resin is a mixture of polyethylene with copolymers of the above type, the copolymer will not exceed 40 weight percent of the base resin mixture. Preferably, such copolymers will comprise from 2 up to about 35 weight percent and, more preferably, 2 to 30 weight percent of the base resin.

In a highly useful embodiment of the invention the polyethylene base resin is an ethylene-C₃₋₈ α-olefin copolymer and, most preferably, an LLDPE or HDPE resin.

Useful LLDPE resins are typically produced by the copolymerization of ethylene with one or more C₃₋₈ α-olefin comonomers using transition metal catalysts in accordance with well-known processes and are characterized by linear molecules having no long-chain branching. Short-chain branching is instead present and is one of the primary determinants of resin density and physical properties. Useful LLDPEs have densities from 0.890 to 0.930 g/cm³ and, more preferably, from 0.906 to 0.930 g/cm³. MIs are typically in the range 0.1 to 10 g/10 min. and, more preferably, from 0.5 to 5 g/10 min. Linear low density polyethylene resins produced using metallocene catalysts, i.e., mLLDPEs, may also be used for the base resin component. LLDPE resins of the above types are highly useful for the production of blown and cast films and, when modified in accordance with the invention, the resulting films exhibit improved printability, i.e., good adhesion, with commonly used inks without surface treatment.

Comonomers typically copolymerized with ethylene to obtain LLDPEs useful for the invention include 1-butene, 4-methyl-1-pentene, 1-hexene, 1-octene and mixtures thereof. By incorporating these comonomers, linear polymer molecules having short-chain branches along the polymer backbone are produced. The amount of comonomer will typically not exceed 35 weight percent and, most commonly, the comonomer comprises from about 2 to 25 weight percent of the LLDPE polymer composition. The specific comonomer or comonomer mixture used is primarily based on process compatibility and the desired resin specifications. LLDPE resins which are copolymers of ethylene and butene-1 and/or hexene-1 are particularly advantageous. For best processability and ease of extrusion of blown films, it is advantageous to use LLDPEs having molecular weight distributions (MWDs) greater than 3. MWD is determined from the weight average molecular weight (Mw) and number average molecular weight (Mn) which are obtained by gel permeation chromatography. MWD=Mw/Mn. LLDPEs useful for the invention are available from commercial sources.

HDPE resins are similarly produced by the copolymerization of ethylene with one or more C₃₋₈ α-olefin comonomers with butene-1 and hexene-1 being preferred. Useful HDPEs will have densities in the range 0.941 to 0.970 g/cm³ and, more typically, from 0.945 to 0.965 g/cm³. In view of the high stiffness of HDPE resins, they are the base resins of choice for injection molding and blow molding applications and, when modified in accordance with the invention, can be used for the manufacture of molded articles having printable surfaces. MIs of the HDPE range from 0.02 to 50 g/10 min. and, most preferably, from 0.05 to 15 g/10 min.

In another highly useful embodiment, particularly where the compositions are to be employed for extrusion coatings, the polyethylene base resin is an LDPE resin. The LDPEs will preferably have densities in the range 0.910 to 0.930 g/cm³ and MIs from about 0.5 to 20 g/10 min.

Polyethylene glycols (PEGs) employed for the invention can be any of several condensation polymers of ethylene glycol known to the art and having average molecular weights from about 500 up to about 20000. PEGs having molecular weights in the range from about 1000 up to about 6000 are particularly advantageous. PEGs having molecular weights and molecular weight distributions suitable for use for the compositions of the invention are commercially available.

Modified polyethylene resins containing acid or acid derivative functionality are combined with the polyethylene base resin and PEG to obtain the improved compositions of the invention. Modified polyethylenes are known and, most commonly, are grafted polyethylenes obtained by reacting unsaturated carboxylic acids and carboxylic acid anhydrides, or derivatives thereof, with polyethylene under grafting conditions. The grafting monomers, i.e., acid, acid anhydride or derivative, are incorporated along the polyethylene backbone. The modified PE components employed for the compositions of the invention are high molecular weight resins and are to be distinguished from low molecular weight maleic anhydride grafts and copolymers having wax-like characteristics employed as dispersants and emulsifying agents. The latter typically have melting points less than 100° C. whereas melting points of the modified PE resins employed for the invention are greater than 110° C.

Polyethylene resins which can be grafted in accordance with known procedures and are useful for the invention include ethylene homopolymer resins and copolymer resins of ethylene with C₄₋₈ α-olefins, preferably butene-1, hexene-1 and octene-1 produced utilizing known polymerization technologies including metallocene and single-site polymerization processes. Also, mixtures of two or more homopolymers and/or copolymers of the above types can be grafted. In a particularly useful embodiment of the invention, the modified polyolefin is a grafted HDPE or grafted LLDPE. Densities and MIs of the HDPE and LLDPE resins grafted will generally be in the same ranges as described for the base resin.

Carboxylic acids or anhydrides useful as grafting monomers include compounds such as acrylic acid, maleic acid, fumaric acid, citraconic acid, mesaconic acid, maleic anhydride, 4-methyl cyclohex-4-ene-1,2-dicarboxylic acid or anhydride, bicyclo(2.2.2)oct-5-ene-2,3-dicarboxylic acid or anhydride, bicyclo(2.2.1)hept-5-ene-2,3-dicarboxylic acid or anhydride, tetrahydrophthalic acid or anhydride, methylbicyclo(2.2.1) hept-5-ene-2,3-dicarboxylic acid or anhydride, nadic anhydride, methyl nadic anhydride, himic anhydride, and methyl himic anhydride. Acid anhydride derivatives which can be used to graft the polyethylene include dialkyl maleates, dialkyl fumarates, dialkyl itaconates, dialkyl mesaconates, dialkyl citraconates and alkyl crotonates. It may be desirable to use a mixture of grafting monomers to vary the physical properties of the modified polyethylene product. Maleic anhydride is a particularly useful grafting monomer.

The amount of carboxylic acid, anhydride or derivative grafted onto the polyolefin can range from about 0.2 up to about 4 wt. %. In a highly useful embodiment of the invention where the modified polyolefin is maleic anhydride grafted HDPE or LLDPE, the amount of maleic anhydride grafted is in the range from about 0.4 to 3.5 wt. % The MI of the graft-modified polyolefin is generally in the range from about 0.5 to about 20 g/10 min.

Grafting is accomplished in accordance with known procedures, generally by heating a mixture of the polyethylene and graft monomer(s) with or without a solvent. Most typically, the grafted products are prepared by melt blending the polyethylene with the grafting monomer in the substantial absence of a solvent in a shear-imparting extruder/reactor. Twin screw extruders such as those marketed by Coperion (formerly Werner-Pfleiderer) under the designations ZSK-53 and ZSK-83 are especially useful for carrying out the grafting operation. A free radical generating catalyst, such as an organic peroxide, can be employed but is not necessary.

To obtain the improved compositions of the invention the base resin, PEG and modified polyethylene are combined and subjected to reactive compounding, i.e., melt mixing all of the components under conditions which impart sufficient mixing and shear to effect a change in rheological properties. More specifically, the mixture is melt blended under conditions to affect at least a 20% increase in melt elasticity (ER) over that of the base resin. It is even more advantageous when the ER of the melt blended composition is 25% or more higher than the ER of the polyethylene base.

ER is a measure of polydispersity derived from rheological data of polymer melts. It is affected by characteristics on a molecular level, e.g., molecular weight distribution, the presence and type of branching, molecular entanglement, etc. Determination of ER utilizes frequency response data in the linear viscoelastic region. That is, ER is derived from the measured dynamic storage modulus, G′, and loss modulus, G″, as a function of frequency. Generally speaking, G′ is a measure of energy stored and recovered per cycle of sinusoidal deformation and G″, is a measure of energy dissipated or lost as heat per cycle. In one method, G′ versus G″ is plotted in logarithmic coordinates. Curves of this sort are generally known as Modified Cole-Cole Plots as described, for example, by E. R. Harrel, et al., in Journal of Applied Polymer Science, Vol. 29, pp. 995-1010 (1984); C. D. Han, et al., in Polymer Engineering Reviews, Vol. 2, No. 2, pp. 135-165 (1982); and N. Nakajima, et al., in Current Topics in Polymer Science, Vol. II, Ottenbrite, et al., Eds., Hanser Publishers (1987), the contents of all of which are incorporated herein by reference, including ASTM D 4440-84 entitled “Standard Practice for Rheological Measurement of Polymer Melts Using Dynamic Mechanical Properties.”

Data can be generated using any rheometer capable of measuring dynamic mechanical properties of polymer melts over a wide range of frequencies, such as a Rheometrics Mechanical Spectrometer Model 605 or 705 or Rheometrics Dynamic Analyzer RDA2 or ARES Analyzer. ER values reported herein were determined at 170° C. for frequencies ranging from 0.0398 to 398 rad/sec using an ARES Analyzer and 25 mm parallel plates. ER is computed by fitting 1 n G′ versus 1 n G″ for the nine lowest frequency points to a linear equation and extrapolating to calculate G′ at G″=5×10³ dynes/cm². ER is then calculated from the equation:
ER=(1.781×10⁻³)G′ at a value of G″=5×10³ dynes/cm²

While the nature and extent of reaction/molecular interaction which occurs during reactive compounding are not fully understood, the result is an increase in ER and unexpected improvement in printability of the resulting composition. Neither the modified polyolefin or PEG, when employed individually with the base resin and melt compounded in the same manner, provide any significant increase in ER or improvement in printability. Based on this observation, it is unexpected that using a combination of the two components with a base resin will produce a significant increase in melt elasticity (ER) upon melt compounding and that the resulting melt compounded product will have significantly improved adhesion for both solvent-based and water-based printing inks.

All of the components can be dry blended or various masterbatching techniques can be employed to combine the components prior to reactive compounding. The use of concentrates or masterbatches is a widely utilized procedure for formulating compositions comprised of a plurality of polymeric components. The procedure is particularly advantageous for incorporating components employed in relatively small amounts and/or where a component is not readily compatible with one or more of the other components and insures intimate and uniform mixing.

In a highly useful embodiment of the invention, the PEG is first melt blended with all or a portion of the base resin and the resulting masterbatch then combined with the modified polyethylene and, optionally, additional base resin and melt blended under conditions sufficient to bring about the requisite increase in ER. This procedure is advantageous since it enables the masterbatch to be prepared in advance and later utilized for preparation of the final product. In such a case, the masterbatch would typically be pelletized and combined with pellets of the modified polyethylene component and, optionally, additional pelletized base resin. This facilitates feeding the materials to the mixer/extruder for the reactive compounding operation. The compositions obtained from the reactive compounding operation may be pelletized for convenient storage and subsequent fabrication.

Additives commonly used for the formulation and fabrication of polyethylene articles may also be included in the compositions. Such additives may include but are not limited to processing aids, antioxidants, heat stabilizers, UV absorbers, antistatic agents, lubricants, fillers and the like. The total amount of such additives will generally not exceed about 5 wt. % of the composition and, most preferably, will range between about 0.01 and 2.5 wt. %. These additives may be added to the other components at any stage of the processing; however, if a masterbatching procedure is used, it is generally advantageous to include the additives in the masterbatch.

Compositions of the invention are readily processable and, depending on the particular base resin used for the formulation, can be used for the manufacture of a wide variety of articles having printable surfaces. For example, the compositions may be used for the production of molded articles and rigid packaging by utilizing a suitable blow molding or injection molding grade polyethylene resin.

More typically, however, compositions of the invention are utilized for the production of printable films and sheets or used for extrusion coating. Films, either blown or cast, having improved printability are readily produced using the compositions of the invention. The base resin used and intended application will be used will generally dictate whether the films will be produced by blowing or casting procedures. Cast films typically have less gauge variation and better clarity whereas blown films are generally considered to have an advantage where strength is a primary consideration. Films produced utilizing the compositions of the invention may be mono-layer films or multi-layer constructions produced by conventional coextrusion processes and having improved printability by virtue of having an outermost layer comprised of a composition of the invention.

Conventional extrusion coating equipment and procedures known to the art can be employed with the compositions of the invention to coat a variety of flexible, rigid and semi-rigid substrates including paper, paperboard, polyethylene synthetic paper, glassine, cellophane, metallized film, polyester film, metal foil, cloth, particle board and the like, typically to a thickness of 0.25 to 5 mils, to provide a surface receptive to printing inks and having other desirable properties.

Even though articles fabricated using the compositions of the invention inherently exhibit greatly improved receptivity to printing inks, both solvent-based and water-based, for certain applications it still may be advantageous to subject the article to surface treatments to further enhance printability or paintability. Conventional surface treatment procedures known to the art for treating polyolefins can be employed for this purpose.

The following examples illustrate the invention; however, those skilled in the art will recognize numerous variations which are within the spirit of the invention and scope of the claims.

For all of the following examples, the compositions were prepared using a two-step procedure wherein a masterbatch of the base resin and polyethylene glycol was first prepared by melt mixing the two components in a Banbury mixer and pelletizing. The pelletized masterbatch was then combined with pelletized modified polyolefin and melt blended under reactive compounding conditions in a twin screw extruder to effect an increase in ER.

Masterbatches were prepared using a Kobelco Stewart Bolling Banbury mixer by introducing a dry blend of the base resin and PEG into the chamber of the mixer maintained at 90° C. Mixing was carried out at 120 rpm and 20 psi ram pressure. Flux was achieved after approximately one minute. The ram was then raised and any material clinging to the throat of the mixer was scraped back into the mixing chamber. Pressure was reapplied and mixing continued for at least 3 minutes. The stock was then dropped into a single screw extruder and pelletized using a strand cut pelletizer. The pelletized masterbatch was then dry blended with pellets of the modified polyolefin and the mixture reactively compounded by passing through at ZSK-30 twin screw extruder/mixer equipped with 10 heating zones maintained at 150° C. up to 230° C. The screw speed was 250 rpm and die temperature was 240° C. The extrudate was strand cut into pellets. ER was determined on the pellets.

Printability was evaluated using 4 inch×4 inch×40 mil thick molded plaques. To prepare the plaques, an amount of the resin composition sufficient to fill the mold cavity was placed in a steel mold. MYLAR® film was placed between the resin sample and the mold faces to insure production of a smooth surface. The mold was paced in a standard compression molder and maintained at 150° C. under 20000 psi pressure for 5 minutes. The MYLAR® film was peeled from the cooled film samples which were then allowed to condition overnight at room temperature.

The entire surface of the conditioned plaques was then covered with a thin ink coating. Coatings were applied with a paint brush and allowed to dry overnight at room temperature. Four different ink formulations (white, black, red and blue) were used for the printability evaluations as follows:
White: A solvent-based white ink formulation comprised of 25 mls commercial coated TiO₂ suspension (TN 15785 ultra white manufactured by Sun Chemical Company, Coated Inks Division) and 100 mls solvent (4:1 mixture of ethyl acetate and propanol).
Black: A commercial water-based blank ink formulation manufactured by CAI Inc. and identified as black 07-8723 w/b slip.
Red: A commercial water-based red ink formulation manufactured by CAI Inc. and identified as Rubin Red (07-8746 w/b Hi Slip).
Blue: A commercial water-based blue ink formulation manufactured by CAI Inc. and identified as Cyan Blue (07-8882 w/b).

To evaluate adhesion, a strip of transparent cellophane tape (grade 610-1 PK manufactured by 3M Company) was applied with finger pressure across the full width of the ink-coated plaque. After 5 minutes, the tape was removed by lifting one end of the tape and pulling across the test specimen. The tape and plaque were then visually examined to determine if any of the ink was removed. A number from 1 to 10 was then assigned to each sample evaluated—10 indicating 100% of the ink adhered to the plaque ranging down to 0 which indicates essentially all of the ink under the tape was removed from the plaque when the tape was lifted. Ink adhesion results reported are the average of three determinations.

### EXAMPLE 1

In accordance with the above-described procedures a composition of the invention comprised of 93 wt. % HDPE, 2 wt. % PEG and 5 wt. % modified polyethylene was prepared and evaluated for ink adhesion. The HDPE resin used was a copolymer of ethylene and hexene-1 having a density of 0.956 g/cm³ and MI of 5 g/10 min. The PEG used had an average molecular weight of 1500. The modified polyethylene was HDPE (density 0.95 g/cm³; MI 9.5 g/l 0 min) grafted with 1.9 wt. % maleic anhydride. To obtain the above composition, 90 wt. % of a masterbatach (97.9 wt. % HDPE; 2 wt. % PEG; 0.1 wt. % phenolic stabilizer) was melt blended with 5 wt. % of the maleic anhydride-grafted HDPE. Whereas the HDPE base resin had an ER of 0.74, after reactive compounding the ER of the melt blended composition was 0.96—an increase of over 29%. The increase in ER is particularly significant considering that when comparative blends comprised of 98 wt. % HDPE and 2 wt. % of the PEG (Comparative Blend A) and 95 wt. % HDPE and 5 wt. % of the maleic anyhydride-grafted HDPE (Comparative Blend B) were identically processed, ERs of the respective blends were only 0.78 and 0.74, respectively.

Printing ink adhesion to the composition of the invention and Comparative Blends A and B was determined and results are set forth in Table I. It is apparent from the data that excellent ink adhesion was obtained with the compositions of the invention whereas there was no adhesion with any of the inks to the comparative blends.

### EXAMPLE II

Another composition was prepared in accordance with the procedure of Example I. The composition was comprised of 94 wt. % HDPE, 1 wt. % PEG and 5 wt. % modified polyethylene. All of the components and procedures used for this example were the same as described in Example I. The composition after reactive compounding had an ER of 0.94—an increase of approximately 27% over that of the HDPE base resin. Ink adhesion results obtained for the composition were comparable to those obtained in Example I and are set forth in Table I.

### Comparative Blend C

To demonstrate the criticality of the modified polyethylene component, Example I was repeated except that the maleic anhydride-grafted HDPE component was replaced with a maleic anhydride-grafted ethylene-propylene copolymer. The copolymer contained 85.2 wt. % propylene, had a melt flow rate of 1 g/10 min and was grafted with 2.17 wt. % maleic anhydride. The ER of the composition was 1.05 after melt compounding in the extruder mixer. Adhesion results are set forth in Table I.

### Comparative Blends D and E

To further demonstrate the criticality of using a combination of PEG and modified polyethylene component, two comparative compositions were prepared in accordance with the procedures of Example II except that the maleic anhydride-grafted HDPE component was replaced with low molecular weight polymers containing maleic functionality manufactured by Baker Petrolite. Comparative Blend E contained 97 wt. % HDPE, base resin, 1 wt. % PEG and 2 wt. % low molecular weight polymer (CERAMER 67 having an average molecular weight 655, acid number 48 and melting point 97° C.) made by grafting a half ester of maleic anhydride onto the polymer backbone. Blend D was comprised of 97 wt. % HDPE, base resin, 1 wt. % PEG and 2 wt. % of a high functionality product (1.5 maleic functions per hydrocarbon function) containing both grafted and copolymerized maleic anhydride (CERAMER 1608 having a number average molecular weight 2580, acid number 154 and melting point of 77° C.). Even though both compositions showed a significant increase in ER when melt compounded in the extruder/mixer, (1.01 and 1.36, respectively) neither composition had acceptable ink adhesion with all of the ink formulations. Ink adhesion results obtained for comparative compositions D and E are provided in Table I.

TABLE 1

Ink Adhesion Rating

| Composition | White | Black | Red | Blue |
|---|---|---|---|---|
| Example I | 10 | 10 | 10 | 10 |
| Comparative Blend A | 0 | 0 | 0 | 0 |
| Comparative Blend B | 0 | 0 | 0 | 0 |
| Example II | 10 | 10 | 10 | 10 |
| Comparative Blend C | 10 | 0 | 8 | 3 |
| Comparative Blend D | 10 | 1 | 1 | 2 |
| Comparative Blend E | 4 | 0 | 0 | 6 |

The ability to achieve improved ink adhesion with the compositions of the invention is apparent from the above results. Complete retention of the applied solvent-based and water-based ink films was obtained only using the PE, PEG, maleic anhydride-grafted polyethylene blends. When either the PEG or graft component was omitted, no increase in ER or ink adhesion was obtained. When the maleic acid-grafted polyethylene component was replaced with other low molecular weight maleic-functionalized products, ink adhesion results were inconsistent with the solvent-based white ink system and consistently poor with the water-based ink systems.

We claim:

1. A composition having improved ink adhesion comprising:
(a) 85 to 98.75 weight percent, based on the total composition, polyethylene base resin,
(b) 0.25 to 5 weight percent, based on the total composition, polyethylene glycol having an average molecular weight from 500 to 20000, and
(c) 1 to 10 weight percent, based on the total composition, modified polyethylene resin containing carboxylic acid or carboxylic acid derivative functionality.

2. The composition of claim 1 wherein base resin (a) is an ethylene homopolymer or copolymer of ethylene and a C₃₋₈ α-olefin having a density from 0.890 to 0.970 g/cm³ and melt index from 0.01 to 50 g/10 min and (c) is a polyethylene resin grafted with 0.2 to 0.4 weight percent unsaturated carboxylic acid or carboxylic acid anhydride.

3. The composition of claim 2 wherein (b) has an average molecular weight from 1000 to 6000.

4. The composition of claim 3 wherein (a) is a copolymer of ethylene and butene-1 or hexene-1.

5. The composition of claim 4 wherein (a) is linear low density polyethylene having a density from 0.906 to 0.930 g/cm³ and melt index from 0.1 to 10 g/10 min.

6. The composition of claim 4 wherein (a) is high density polyethylene having a density from 0.945 to 0.965 and melt index from 0.05 to 15 g/10 min.

7. The composition of claim 2 wherein (a) is low density polyethylene having a density from 0.910 to 0.930 g/cm³ and melt index from 0.5 to 20 g/10 min.

8. The composition of claim 2 comprising 90 to 96 weight percent (a), 0.5 to 4 weight percent (b) and 2.5 to 7.5 weight percent (c).

9. The composition of claim 2 wherein (c) is a high density polyethylene resin or linear low density polyethylene resin grafted with 0.2 to 4 weight percent maleic anhydride.

10. The composition of claim 2 wherein the components are melt blended under conditions of mixing and shear such that the melt elasticity is at least 20% greater than that of the polyethylene base resin (a).

11. The process for producing polyethylene articles having improved printability comprising:
(a) combining (i) 85 to 98.75 weight percent, based on the total composition, polyethylene resin, said resin having a density from 0.890 to 0.970 g/cm³ and melt index from 0.01 to 50 g/10 min and selected from the group consisting of ethylene homopolymers and copolymers of ethylene and C₃₋₈ α-olefins, (ii) 0.25 to 5 weight percent, based on the total composition, polyethylene glycol having an average molecular weight from 500 to 20000, and (iii) 1 to 10 weight percent, based on the total composition, polyethylene resin grafted with 0.2 to 4 weight percent unsaturated carboxylic acid or carboxylic acid anhydride;
(b) melt blending the product obtained from step (a) under conditions of mixing and shear such that the melt elasticity of the resulting composition is at least 20% greater than that of polyethylene resin (i); and
(c) fabricating the melt blended product obtained from step (b) to produce an article having a printable surface.

12. The process of claim 11 wherein (i) is linear low density polyethylene having a density from 0.906 to 0.930 g/cm³ and melt index from 0.1 to 10 g/10 min, (ii) has an average molecular weight from 1000 to 6000 and (iii) is a high density polyethylene resin or linear low density polyethylene resin grafted with 0.2 to 4 weight percent maleic anhydride.

13. The process of claim 11 wherein (i) is high density polyethylene having a density from 0.945 to 0.965 g/cm³ and melt index from 0.05 to 15 g/10 min, (ii) has an average molecular weight from 1000 to 6000 and (iii) is a high density polyethylene resin or linear low density polyethylene resin grafted with 0.2 to 4 weight percent maleic anhydride.

14. The process of claim 11 wherein (i) is low density polyethylene having a density from 0.910 to 0.930 g/cm³ and melt index from 0.5 to 20 g/10 min, (ii) has an average molecular weight from 1000 to 6000 and (iii) is a high density polyethylene resin or linear low density polyethylene resin grafted with 0.2 to 4 weight percent maleic anhydride.

15. The process of claim 11 wherein (i) and (ii) are combined, melt blended and pelletized prior to mixing with (iii).

16. The process of claim 11 wherein the melt blended product obtained from step (b) is pelletized prior to fabrication.

17. The process of claim 11 wherein the melt blended product obtained from step (b) is fabricated into film or sheet.

18. The process of claim 11 wherein the melt blended product obtained from step (b) is extrusion coated onto a flexible, rigid or semi-rigid substrate.
